(19) United States
(12) Patent Application Publication
(10) Pub. No.: US 2006/0142044 A1
(43) Pub. Date: Jun. 29, 2006

(54) Apparatus and method for controlling power in mobile terminal having diversity receiver

(75) Inventor: Hak-Jea Sung, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/320,329

(22) Filed: Dec. 28, 2005

(30) Foreign Application Priority Data
Dec. 29, 2004 (KR) 10-2004-0115114

(51) Int. Cl. H04Q 7/20

(52) U.S. Cl. 455/522; 455/69

(57) ABSTRACT

Disclosed is an apparatus for controlling a transmission (TX) power in a mobile terminal having at least two receive (RX) antennas. The apparatus includes a TX gain estimator for determining an AGC gain value corresponding to the estimated TX power; a compensation gain detector for determining a gain compensation value corresponding to the calculated difference; a closed-loop power controller for determining an up/down value of the TX power based on a power control bit received from a base station; and a TX gain determiner for determining a final AGC gain value.

This application claims priority under 35 U.S.C. §119 to an application entitled “Apparatus and Method For Controlling Power In Mobile Communication Terminal With Diversity Receiver” filed in the Korean Intellectual Property Office on Dec. 29, 2004 and assigned Ser. No. 2004-0115114, the contents of which are incorporated herein by reference.

### BACKGROUND OF THE INVENTION

1. Field of the Invention

The present invention relates to an apparatus and method for controlling TX (Transmission) power in a mobile terminal, and more particularly, to an apparatus and method for compensating low initial TX power due to an increased gain at an RX (Reception) port in a mobile terminal with a diversity receiver.

2. Description of the Related Art

Mobile terminals are widely used. With the increasing use of the mobile terminals, service providers (and terminal manufacturers) have made efforts to provide a more stable and reliable call quality and various services.

In mobile communication systems, signals received at a base station from a mobile terminal have different power depending upon a distance between the mobile terminal and the base station. Also, signals face fading when transmitted from the mobile terminals to the base station. In order to provide a more stable and reliable call quality and to maximize a subscriber capacity, transmission or transmit (TX) power must be controlled for providing a long operating range in a reverse link.

At a low TX power, the mobile terminal has a low call quality, while at a high TX power the mobile terminal has a high call quality. The high TX power, however, causes great interference to other mobile terminals using the same channels, resulting in a low call quality of the interfered mobile terminals.

Accordingly, in order to provide a high call quality to all subscribers and to maximize a subscriber capacity, TX power of mobile terminals must be controlled so that signals received at the base station from the mobile terminals have the same power and a minimum signal-to-interference ratio (SIR).

FIG. 1 is a diagram illustrating a process for controlling an initial TX power in a general mobile terminal.

Referring to FIG. 1, in Step 101, the mobile terminal receives a signal from a base station so as to estimate an initial TX power of a signal to be transmitted to the base station. In Step 103, the mobile terminal estimates the initial TX power on the basis of a power level of the received signal and a predetermined table for estimating a TX power from an RX power. An exemplary embodiment of the predetermined table is illustrated below in Table 1.

TABLE 1

| RX | | | |
|---|---|---|---|
| PWR (dBm) | TX PWR (dBm) | RX PWR (dBm) | TX PWR (dBm) |
| −106 | 30 | −58.3 | −17.7 |
| −100.7 | 24.7 | −53 | −23 |
| −95.4 | 19.4 | −47.7 | −28.3 |
| −90.1 | 14.1 | −42.4 | −33.6 |
| −84.8 | 8.8 | −37.1 | −38.9 |
| −79.5 | 3.5 | −31.8 | −44.2 |
| −74.2 | −1.8 | −26.5 | −49.5 |
| −68.9 | −7.1 | −21.2 | −54.8 |
| −63.6 | −12.4 | | |

Table 1 shows a relationship between a receive (RX) power and a TX power in a personal communication service (PCS) phone.

The relationship can also be expressed using Equations 1 and 2 shown below.

Equation 1 expresses a relationship between an RX power and a TX power in an open-loop mode in a cellular phone.
TX Power (dBm)=−RSSI−73 Equation 1

Where, TX power represents a transmission power from the mobile terminal to the base station and RSSI(Received Signal Strength Indication) represents a received signal strength. Equation 2 expresses a relationship between an RX power and a TX power in an open-loop mode in a PCS phone.
TX Power (dBm)=−RSSI−76 Equation 2

Where, as in Equation 1, TX power and RSSI represent a transmission power from the mobile terminal to the base station and a received signal strength, respectively. For example, using Table 1, when an RX power is −53 dBm, the mobile terminal estimates a TX power to be −23 dBm.

Referring back to FIG. 1, in Step 105, the mobile terminal transmits the estimated TX power to the base station at an initial access power so that the base station can receive the same power from a plurality of mobile terminals regardless of the mobile terminals positions and thus more users can perform a call through the base station.

FIG. 2 is a block diagram of a device for controlling a TX power in a conventional mobile terminal having a single antenna.

Referring to FIG. 2, a single antenna 201 transmits and receives a radio frequency (RF) signal. A duplexer 203 enables the mobile terminal to perform both TX and RX operations through the antenna 201.

A low-noise amplifier (LNA) 205 amplifies an RX RF signal which has a low power level due to attenuation and noise, while minimally amplifying noise of the RX signal, and provides the amplified RF signal to an RF unit 207. The RF unit 207 converts the amplified RF signal into a baseband signal by removing spurious signals from the amplified RF signal and then removing a carrier frequency component from the resulting signal by using a local oscillation (LO) frequency, and provides the baseband signal to an RX automatic gain control amplifier (RX AGC AMP) 209.

The RX AGC AMP 209 receives the baseband signal from the RF unit 207 and amplifies the RX signal so as to provide a signal of constant strength to an input port of a baseband analog unit (BBA) 211 and thus improve a call quality.

The BBA 211 receives the amplified signal from the RX AGC AMP 209, measures an RSSI of the RX signal, and converts the RX signal into an analog signal. Also, the BBA 211 provides the RX signal to a modem 213, an RX path automatic gain control loop (RX PATH AGC LOOP) unit 215 and a closed-loop power controller 217.

The modem 213 receives the baseband signal from the BBA 211, performs an IS-95 protocol on the received baseband signal and provides the resulting RX data to an upper layer. Also, the modem 213 receives TX data from the upper layer and provides the received TX data to the BBA 211.

The RX PATH AGC LOOP unit 215 receives the RSSI of the RX signal from the BBA 211, estimates a TX power corresponding to the power of the RX signal by referring to Table 1, and generates an AGC value corresponding to the estimated TX power.

The closed-loop power controller 217 receives the RX signal from the BBA 211 and detects a closed-loop power signal for finely controlling a power value set by open-loop power control. The closed-loop power controller 217 despreads the received RX signal using a finger (not shown) and extracts a power control bit from the RX signal received from the base station. When the power control bit is a “1”, the closed-loop power controller 217 generates a gain control value for decreasing a TX power by 1 dB. On the contrary, when the power control bit is a “0”, the closed-loop power controller 217 generates a gain control value for increasing the TX power by 1 dB.

An adder 219 calculates the final AGC value by adding the AGC value from the RX PATH AGC LOOP unit 215 and the gain control value from the closed-loop power controller 217.

Here, a gain value for estimating the initial access TX power (as opposed to power control during a call mode) is calculated using only the AGC value from the RX PATH LOOP unit 215. In contrast, for TX power control during a call mode, a gain value for estimating the final TX power is calculated using the final AGC value from the adder 219.

A TX AGC AMP 221 amplifies the TX signal from the BBA 211 by the final AGC value from the adder 219.

An RF unit 223 converts the amplified TX signal into a TX frequency band signal, removes unnecessary frequency components from the TX frequency band signal, and outputs the resulting signal to a power amplifier 225. The power amplifier 225 amplifies the resulting signal from the RF unit 223 so that a signal of sufficient power is transmitted through a final port. The amplified signal from the power amplifier 225 is transmitted through the duplexer 203 and the antenna 201.

Meanwhile, when the mobile terminal uses a single antenna 201 as described above, the, a call quality is degraded due to multi-path fading. A mobile terminal having a diversity receiver has been developed so as to prevent the degradation of a call quality due to the multi-path fading.

The mobile terminal having a diversity receiver also estimates an initial access TX power through the same manner as the mobile terminal having a single antenna. Since the mobile terminal having a diversity receiver uses at least two RX antennas and thus has an increased gain at its RX port, it may detect a higher RX power and thus may estimate an initial access TX power which is lower than an initial access TX power of a mobile terminal having a single antenna.

For example, with reference to Table 1, when the mobile terminal having a single antenna receives an RX signal having power of −53 dBm and estimates its TX power to be −23 dBm, a mobile terminal having a diversity receiver using two RX antennas determines that it receives an RX signal having power of −26.5 dBm (which is higher than −53 dBm), and thus estimates its TX Power to be “−49.5 dBm” (which is lower than −23 dBm). Accordingly, the mobile terminal having the diversity receiver suffers from degradation.

### SUMMARY OF THE INVENTION

The present invention provides an apparatus and method for controlling an initial access transmission (TX) power in a mobile terminal having a diversity receiver.

Also, the present invention provides an apparatus and method for controlling an initial access TX power in a mobile terminal having a diversity receiver by using a difference between a receive (RX) power of a first antenna and the total power of the diversity receiver.

Further, the present invention provides an apparatus and method for controlling a reverse link open-loop power in a mobile terminal having a diversity receiver.

According to an aspect of the present invention, an apparatus for controlling a TX power in a mobile terminal having at least two RX antennas includes a TX gain estimator for measuring a total power of RX signals received through the RX antennas, estimating a TX power based on the measured total power, and determining an AGC gain value corresponding to the estimated TX power; a compensation gain detector for measuring a power of one of the RX signals, calculating a difference between the measured total power and the measured power of one of the RX signals, and determining a gain compensation value corresponding to the calculated difference; a closed-loop power controller for determining an up/down value of the TX power based on a power control bit received from a base station; and a TX gain determiner for determining a final AGC gain value by using the determined AGC gain value from the TX gain estimator, the determined gain compensation value from the compensation gain detector and the determined up/down value from the closed-loop power controller.

According to another aspect of the present invention, a method for controlling an initial TX power in a mobile terminal having at least two RX antennas includes measuring a total power of RX signals received through the RX antennas and a power of one of the RX signals; calculating a difference between the measured total power of the RX signals and the measured power of one of the RX signals and determining a gain compensation value corresponding to the calculated difference; estimating a TX power based on the measured total power and determining an AGC gain value corresponding to the estimated TX power; and determining a final AGC gain value by using the determined AGC gain value and the determined gain compensation value.

According to a further another aspect of the present invention, a method for controlling a reverse link power in a mobile terminal having at least two RX antennas includes: measuring a total power of RX signals received through the RX antennas and a power of one of the RX signals; calculating a difference between the measured total power of the RX signals and the measured power of one of the RX signals and obtaining an AGC gain compensation value corresponding to the calculated difference and a TX power up/down value according to a closed-loop power; estimating a TX power based on the measured total power and determining an AGC gain value corresponding to the estimated TX power; and determining a final AGC gain value by using the determined AGC gain value and the obtained gain compensation value.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a process for controlling an initial TX power in a general mobile terminal;

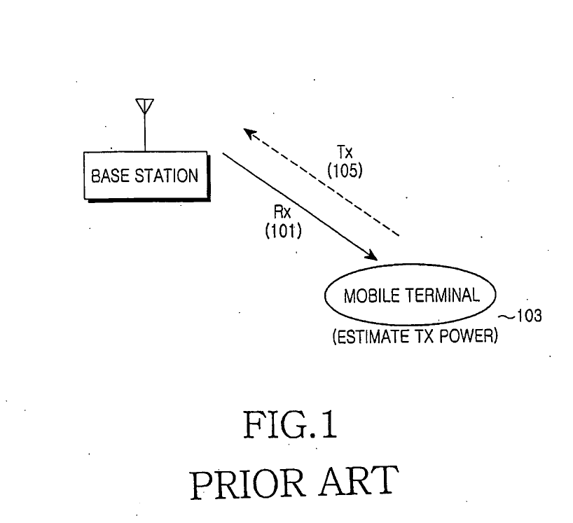

FIG. 2 is a block diagram of a device for controlling a TX power in a conventional mobile terminal having a single antenna;

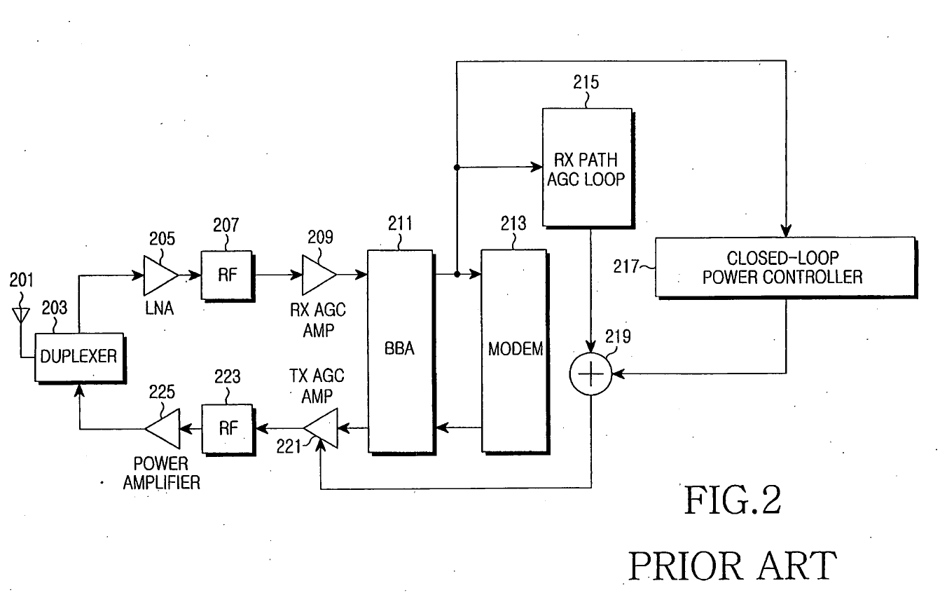

FIG. 3 is a block diagram of an apparatus for controlling a TX power in a mobile terminal having a diversity receiver according to an embodiment of the present invention;

FIG. 4 is a flowchart illustrating a process for controlling an initial TX power in a mobile terminal according to an embodiment of the present invention; and

FIG. 5 is a flowchart illustrating a process for controlling a reverse link power in a mobile terminal according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. A detail description of well-known features will be omitted for conciseness.

The present invention proposes a method for compensating an initial access TX power in a mobile terminal having a diversity receiver. It should be noted that the mobile terminal includes various kinds of mobile terminals, such as a cellular phone, a personal communication system (PCS) phone, a personal data assistant (PDA) terminal, an international mobile communication-2000 (IMT-200) terminal, and an orthogonal frequency division multiplexing (OFDM) terminal, each of which having a diversity receiver.

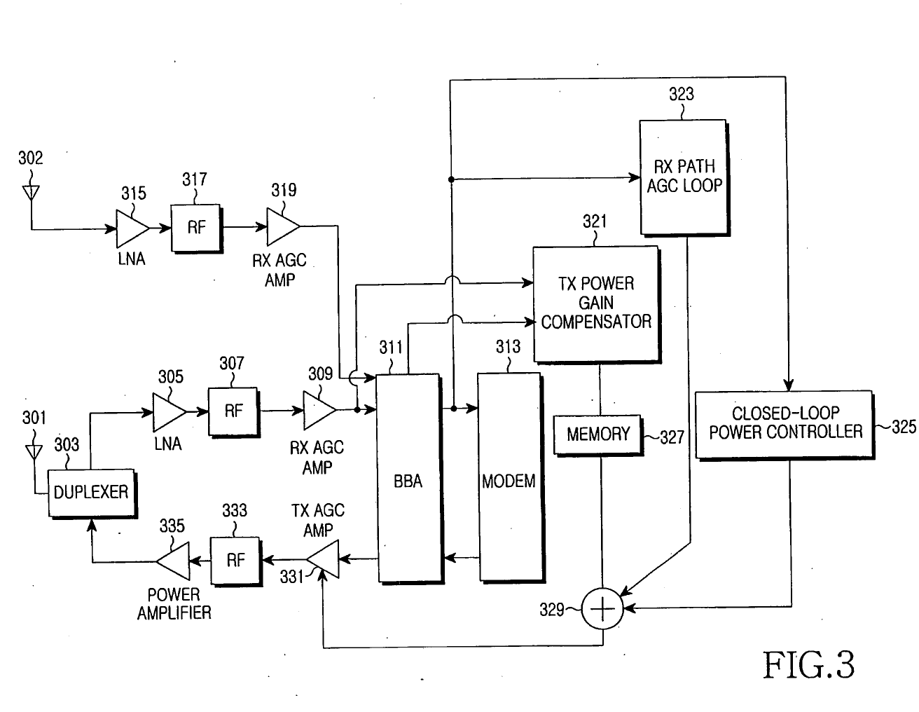

The following description provides a description of diversity terminals. For example, with reference to FIG. 3, a description is provided using a mobile terminal having a diversity antenna using two RX antennas.

FIG. 3 is a block diagram of an apparatus for controlling a TX power in a mobile terminal having a diversity receiver according to an embodiment of the present invention.

Referring to FIG. 3, a first antenna 301 transmits and receives a radio frequency (RF) TX and/or RX signal, respectively. A duplexer 303 enables the mobile terminal to perform both TX and RX operations through first antenna 301.

An LNA 305 amplifies the RF RX signal, which has a very low power level due to attenuation and noise, while minimally amplifying noise contained in the RX signal, and provides the amplified RF signal to an RF unit 307. The RF unit 307 converts the amplified RF signal into a baseband signal by removing spurious signals from the amplified RF signal and then removing a carrier frequency component from the resulting signal by using a local oscillation (LO) frequency.

An RX AGC AMP 309 receives the baseband signal from the RF unit 307 and amplifies the RX signal so as to provide a signal of constant strength to an input port of a BBA 311 and thus improve a call quality. The amplified RX signal is provided to the BBA 311 and a TX power gain compensator 321.

A second antenna 302 receives an RF RX signal.

An LNA 315 amplifies the RF RX signal while minimally amplifying noise contained in the RX RF signal, and provides the amplified RF signal to an RF unit 317. The RF unit 307 converts the amplified RF signal into a baseband signal by removing spurious signals from the amplified RF signal and then removing a carrier frequency component from the resulting signal by using a local oscillation (LO) frequency.

An RX AGC AMP 319 receives the baseband signal from the RF unit 317 and automatically controls a gain of the RX signal so as to provide a signal of constant strength to an input port of a BBA (it is a BBA ASIC, hereinafter called BBA) 311 and thus improve a call quality. The amplified RX signal is provided to the BBA 311.

The BBA 311 receives the RX signals of the first and second antennas 301 and 302, respectively, measures and adds RSSI values of the RX signals, and converts a received signal into an analog signal. Also, the BBA 311 provides the RSSI values the TX power gain compensator 321 and an RX PATH AGC LOOP unit 323, and provides the RX signals to a modem 313 and a closed-loop power controller 325.

The modem 313 receives the baseband signal from the BBA 311, performs an IS-95 protocol on the received baseband signal, and provides the resulting RX data to an upper layer. Also, the modem 313 receives TX data from the upper layer and provides the received TX data to the BBA 311.

The TX power gain compensator (also known as a compensation gain detector) 321 measures an RSSI value of an RX signal of the first antenna 301, calculates a difference value between the measured RSSI value and the total RSSI value from the BBA 311, obtains a gain compensation value for the difference value by referring to a predetermined table storing a gain value for the difference value and stores the obtained gain compensation value in a memory 327.

The RX PATH AGC LOOP unit (also known as a TX gain estimator) 323 receives the RSSI values of the RX signals from the BBA 311, estimates a TX power corresponding to the power of the RX signal by referring to a look-up table (e.g., Table 1) and generates an AGC value corresponding to the estimated TX power.

The closed-loop power controller 325 receives the RX signal from the BBA 311 and detects a closed-loop power signal for finely controlling a power value set by an open-loop power control. That is, the closed-loop power controller 325 despreads the received RX signal using a finger (not shown) and extracts a power control bit from the RX signal received from the base station. When the power control bit is a “1”, the closed-loop power controller 325 generates a gain control value for decreasing a TX power by 1 dB. In contrast, when the power control bit is a “0”, the closed-loop power controller 325 generates a gain control value for increasing the TX power by 1 dB.

An adder (also known as a TX gain determiner) 329 calculates the final AGC value by adding the AGC value from the RX PATH AGC LOOP unit 323, the gain control value from the closed-loop power controller 325 and the RSSI values and the gain compensation value for the RSSI difference value that are stored in the memory 327.

Here, a gain value for estimating the initial access TX power is calculated by adding the AGC value from the RX PATH AGC LOOP unit 323 with the gain compensation value stored in the memory 327. In contrast, for TX power control during a call mode, a gain value for estimating the final TX power is calculated by adding the AGC value from the RX PATH AGC LOOP unit 323 and the gain control value from the closed-loop power controller 325 with the gain compensation value stored in the memory 327.

A TX AGC AMP 331 amplifies the TX signal from the BBA 311 by the final AGC value from the adder 329.

An RF unit 333 converts the amplified TX signal into a TX frequency band signal, removes unnecessary frequency components from the TX frequency band signal, and outputs the resulting signal to a power amplifier 335. The power amplifier 335 amplifies the resulting signal from the RF unit 333 so that a signal of sufficient power is transmitted through a final port. The amplified signal from the power amplifier 335 is transmitted through the duplexer 303 and the first antenna 301.

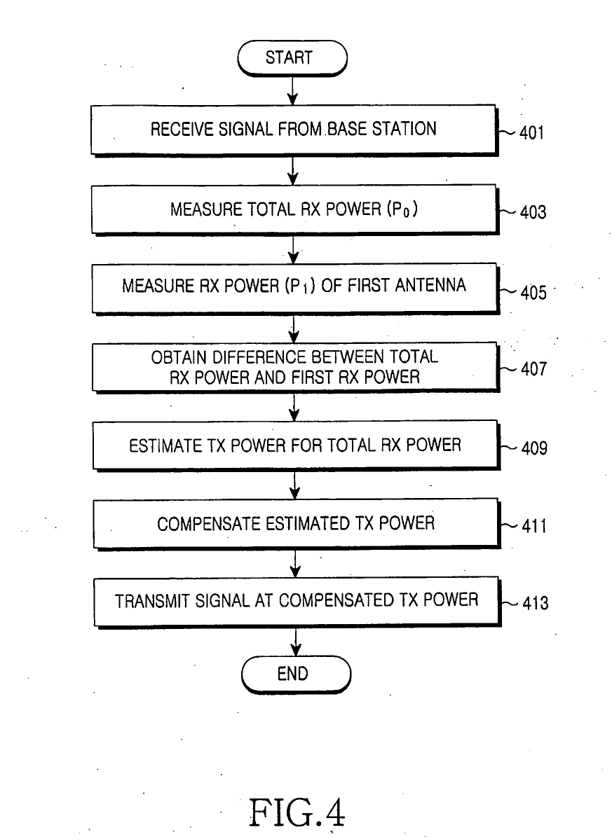

FIG. 4 is a flowchart illustrating a process for controlling an initial TX power in the mobile terminal according to an embodiment of the present invention. Referring to FIG. 4, the mobile terminal receives RX signals from a base station in Step 401. Here, the mobile terminal has a diversity receiver using two antennas, that is, first and second antennas. In Step 403, the mobile terminal measures the total power P₀ of the RX signals received through the two antennas.

In Step 405, the mobile terminal measures the power P₁ of the first Rx signal. In Step 407, the mobile terminal calculates a difference value between the total power P₀ and the power P₁ and stores the measured difference value in a memory (e.g., the memory 327).

In Step 409, the mobile terminal estimates a TX power for the total power P₀ by referring to a look-up table (e.g., Table 1). In Step 411, the mobile terminal compensates the estimated TX power by adding the stored difference value to the estimated TX power. The mobile terminal transmits a signal at the compensated TX power in Step 413 and then ends the process.

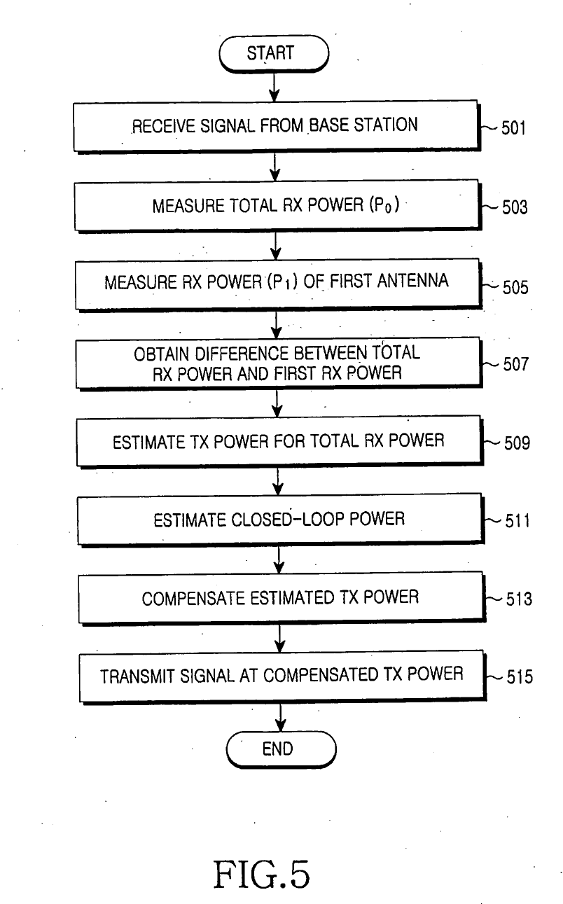

FIG. 5 is a flowchart illustrating a process for controlling a reverse link power in the mobile terminal according to an embodiment of the present invention. Referring to FIG. 5, the mobile terminal receives RX signals from a base station in Step 501. Here, the mobile terminal has a diversity receiver using two antennas, that is, first and second antennas. In Step 503, the mobile terminal measures the total power P₀ of the RX signals received through the two antennas. In Step 505, the mobile terminal measures the power P₁ of the first Rx signal.

In Step 507, the mobile terminal calculates a difference value between the total power P₀ and the power P₁ and stores the measured difference value in a memory (e.g., the memory 327). In Step 509, the mobile terminal estimates a TX power for the total power P₀ by referring to a table look-up (e.g., Table 1).

In Step 511, the mobile terminal obtains an up/down value of the TX power for closed-loop power control. The closed-loop power is used for finely controlling a power value set by open-loop power control. During the closed-loop power control by the up/down value of the TX power, the mobile terminal detects a power control bit of the Rx signal received from the base station. When the detected power control bit is 1, the mobile terminal decreases the TX power by 1 dB, and when the detected power control bit is a 1, the mobile terminal increases the TX power by 1 dB. Here, the power control bit is determined by using an Energy per bit to Spectral Noise Density (Eb/No) value of a signal received from the mobile terminal.

In Step 513, the mobile terminal compensates the estimated TX power by adding the closed-loop power and the stored difference value to the estimated TX power. The mobile terminal transmits a signal at the compensated TX power in Step 515 and then ends the process.

As described above, the apparatus and method according to the present invention can prevent degradation in reception of the mobile terminal having a diversity receiver by controlling the initial TX power of the mobile terminal. That is, the conventional mobile terminal having a diversity receiver detects a high RX power due to an increased gain at its RX port and thus underestimates an initial TX power. However, the present invention compensates the underestimated initial TX power by adding the difference value between the total RX power and the first RX power to the underestimated initial TX power, thereby making it possible to prevent the reception degradation of the mobile terminal.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for controlling a transmission (TX) power in a mobile terminal having at least two reception (RX) antennas, the apparatus comprising:
a TX gain estimator for measuring a total power of RX signals received through the at least two RX antennas, estimating a TX power based on the measured total power, and determining an AGC gain value corresponding to the estimated TX power;
a compensation gain detector for measuring a power of one of the RX signals, calculating a difference between the measured total power and the measured power of one of the RX signals, and determining a gain compensation value corresponding to the calculated difference;
a closed-loop power controller for determining an up/down value of the TX power based on a power control bit received from a base station; and
a TX gain determiner for determining a final AGC gain value using the determined AGC gain value, from the TX gain estimator, the determined gain compensation value from the compensation gain detector, and the determined up/down value from the closed loop power controller.

2. The apparatus of claim 1, wherein the TX gain estimator estimates the TX power and determines the AGC gain value by referring to a predetermined table.

3. The apparatus of claim 1, wherein the compensation gain detector determines the gain compensation value by referring to a predetermined table.

4. The apparatus of claim 1, further comprising a memory for temporarily storing the gain compensation value.

5. The apparatus of claim 1, wherein the closed-loop power controller increases or decreases the TX power by 1 dB according to the power control bit included in a signal received from the base station.

6. The apparatus of claim 1, wherein the total power of RX signals is received from a Base Band Analog (BBA).

7. A method for controlling an initial transmission (TX) power in a mobile terminal having at least two reception (RX) antennas, the method comprising the steps of:
measuring a total power of RX signals received through the at least two RX antennas and a power of one of the RX signals;
calculating a difference between the measured total power and the measured power of one of RX antennas and determining a gain compensation value corresponding to the calculated difference;
estimating a TX power based on the measured total power and determining an automatic gain control (AGC) gain value corresponding to the estimated TX power; and
determining a final AGC gain value by using the determined AGC gain value and the determined gain compensation value.

8. The method of claim 7, further comprising the steps of:
storing the gain compensation value in a memory; and
receiving the stored gain compensation value from the memory for the determination of the final AGC gain value.

9. A method for controlling a reverse link power in a mobile terminal having at least two reception (RX) antennas, the method comprising the steps of:
measuring a total power of RX signals received through the at least two RX antennas and a power of one of the RX signals;
calculating a difference between the measured total power and the measured power of one of the RX signals and obtaining a gain compensation value corresponding to the calculated difference and a transmission (TX) power up/down value according to a closed-loop power;
estimating a TX power based on the measured total power and determining an automatic gain control (AGC) gain value corresponding to the estimated TX power; and
determining a final AGC gain value by using the determined AGC gain value and the obtained gain compensation value.

10. The method of claim 9, further comprising the steps of:
storing the obtained gain compensation value in a memory; and
receiving the stored gain compensation value from the memory when determining the AGC gain value for the determination of the final AGC gain value.

11. The method for claim 9, wherein a base station receives a signal from the mobile terminal and increases or decreases the TX power of the mobile terminal by 1 dB according to a frame error rate of the received signal.
